(19) United States
(12) Patent Application Publication
(10) Pub. No.: US 2006/0042805 A1
(43) Pub. Date: Mar. 2, 2006

(54) Tool holder

(76) Inventor: Tamara M. Sandlin, Carmel, IN (US)

Correspondence Address: FRASER MARTIN & MILLER LLC, 132 WEST SECOND STREET, PERRYSBURG, OH, 43551, US

(21) Appl. No.: 11/211,836

(22) Filed: Aug. 25, 2005

Related U.S. Application Data
(60) Provisional application No. 60/604,749, filed on Aug. 26, 2004.

(51) Int. Cl. A01B 29/06

(52) U.S. Cl. 172/126

(57) ABSTRACT

A tool holder is disclosed which stores and organizes a plurality of tools which are releasably attached to the tool holder, wherein an efficiency of use of the tools is maximized.

### CROSS-REFERENCE TO RELATED APPLICATION

This application claims priority to U.S. provisional patent application 60/604,749, filed Aug. 26, 2004, hereby incorporated herein by referenced in its entirety.

### FIELD OF THE INVENTION

The invention relates to a tool holder and more particularly to a tool holder for storing and organizing a plurality of tools, the tools releasably attached to the tool holder.

### BACKGROUND OF THE INVENTION

Tasks of every day life typically require the use of a variety of tools and devices to assist with accomplishing the tasks. Storage and organization of the tools often presents a problem, especially when the tools being used are relatively small in size. The tools can be misplaced or lost, and known organizers are often not suited for portability and do not provide easy access to the tools.

These problems are especially true in the medical field where health care providers must carry a number of tools to assist in administering care. Additionally, the tools must be quickly and easily accessible to the health care providers to facilitate providing efficient care. Such tools may include a knife, tweezers, a staple remover, an identification badge, scissors, a thermometer, a hemostat, a flashlight or other lighting device, a calculator, a micrometer, calipers, keys, a reflex hammer, a pen, a marker, and the like, for example.

It would be desirable to produce a tool holder for conveniently organizing and storing a plurality of tools to be carried by a user wherein an efficiency of use of the tools is maximized.

### SUMMARY OF THE INVENTION

Consistent and consonant with the present invention, a tool holder for conveniently organizing and storing a plurality of tools to be carried by a user wherein an efficiency of use of the tools is maximized, has surprisingly been discovered.

In one embodiment, the tool holder comprises a main body adapted to be attached to a support structure; a fastener rack disposed on the main body; and a plurality of link members depending from the rack, each of the link members adapted to releasably receive a tool therein, wherein the tool can be released from the link member during use.

In another embodiment, the tool holder comprises a main body adapted to be attached to a support structure, the main body including a plurality of recesses formed therein; a link member disposed in each of the recesses of the main body, each link member adapted to releasably receive a tool therein, wherein the tool can be released from the link member during use; and at least one retaining member disposed between the main body and the link members to attach the link members to the main body.

In another embodiment, the tool holder comprises a main body adapted to be attached to a support structure; a fastener rack disposed on the main body including a plurality of recesses formed therein; at least one retaining member extending through the recesses of the rack; and a link member disposed in each of the recesses of the rack and depending from the retaining member, each link member adapted to releasably receive a tool therein, wherein the tool can be released from the link member during use.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a front elevational view of a tool holder according to an embodiment of the invention; and

FIG. 2 is a side elevational view of the tool holder illustrated in FIG. 1.

### DESCRIPTION OF THE PREFERRED EMBODIMENT

The following detailed description and appended drawings describe and illustrate exemplary embodiments of the invention. The description and drawings serve to enable one skilled in the art to make and use the invention, and are not intended to limit the scope of the invention in any manner.

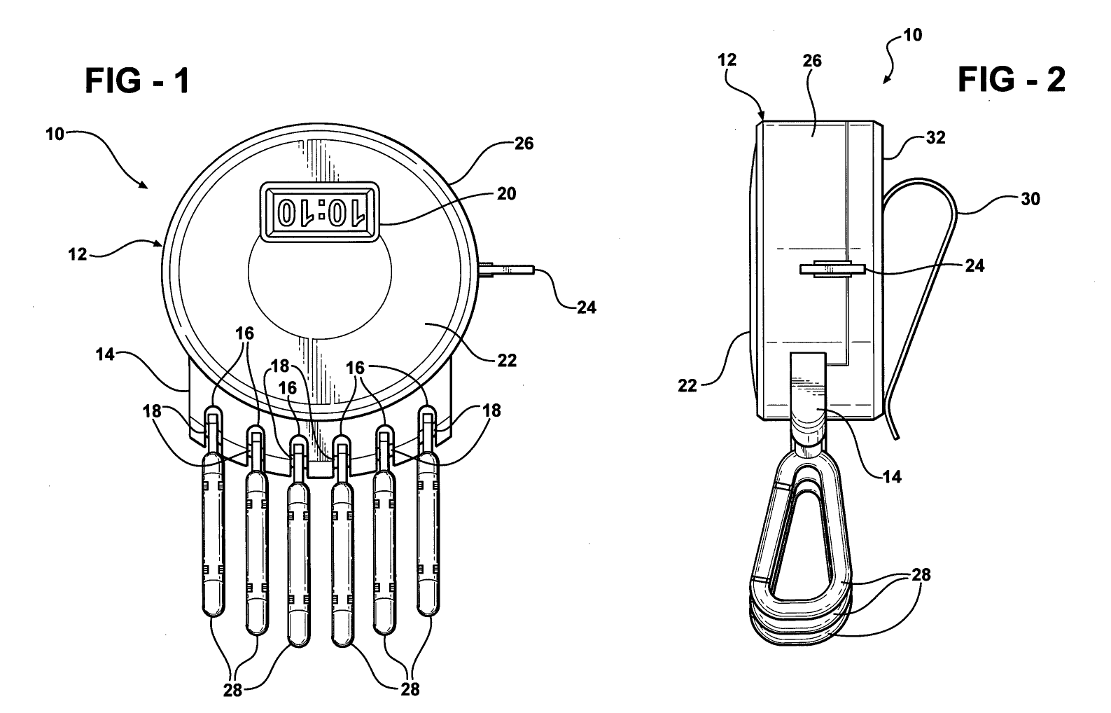

FIG. 1 illustrates a tool holder 10 according to an embodiment of the invention. The tool holder 10 includes a main body 12. In the embodiment shown, the main body 12 has a substantially circular cross-sectional shape, although other cross sectional shapes can be used as desired. The main body 12 includes a fastener rack 14 attached thereto. The main body 12 and the rack 14 can be formed from any conventional material. Favorable results have been found using stainless steel, aluminum, plastic, or other corrosion resistant materials. A plurality of recesses 16 is formed in the rack 14. Although six recesses 16 are included in the embodiment shown, more or fewer recesses 16 can be provided as desired. As used herein, the recess 16 is intended to mean a channel, an indentation, an aperture, a hole, a gap, a cut, a notch, and the like, for example.

A retaining member 18 is disposed in each of the recesses 16. In the embodiment shown, the retaining member 18 extends across a width of each of the recesses 16. It is understood that the retaining members 18 can be formed from a single pin or rod and the like and inserted into the rack 14 to extend through each of the recesses 16; formed integrally with the rack 14; or formed from a plurality of pins or rods and the like which extend through each individual recess 16, as desired. Additionally, the retaining member can be a spring loaded detent formed in the recess, or formed on a cooperating structure as will be further described herein below, for example.

The main body 12 includes a clock 20 disposed in a first surface 22 thereof. The clock 20 can include a timer or stop watch component to assist a user in timing an event, such as taking a pulse of a patient, for example. In the embodiment shown, the clock 20 is inverted to facilitate a viewing thereof from a point located above the tool holder 10. The clock 20 can be waterproof or water resistant, if desired, to increase the durability of the tool holder 10. To assist in viewing of the clock 20 in poorly lit areas, a display area of the clock 20 is provided with a source of light which illuminates the display area.

A measuring tape 24 is disposed in the main body 12. The measuring tape 24 extends through an aperture formed in a peripheral wall 26 of the main body 12 to facilitate dispensing and retracting of the measuring tape 24. The measuring tape 24 can be any conventional type of measuring tape, as desired. Any conventional material can be used for a tape portion of the measuring tape 24 such as cloth, flexible plastic, or steel, for example. In the embodiment shown, the tape portion of the measuring tape 24 is formed from a non-metallic material which can be easily cleaned.

Typically, the measuring tape 24 is urged by a coil spring (not shown) to assist in retracting the measuring tape 24 into the main body 12. An internal ratcheting or self locking mechanism (not shown) can be used to lock the measuring tape 24 in place upon extension of the tape portion from the main body 12. The mechanism can be released by a release button (not shown) or release upon a further extension of the tape portion. Although any length of the tape portion can be used, favorable results have been found by using a tape portion having a length of at least 36 inches.

Additional structures (not shown) can be formed on or attached to the main body 12, as desired. These structures can be one or more structure such as clips, pouches, pockets, storage compartments, and the like, for example.

A link member 28 is held in each of the recesses 16 by the retaining members 18. The link member 28 can be formed from any conventional material. Favorable results have been found using stainless steel, aluminum, plastic, or other corrosion resistant materials. The link member 28 is adapted to receive and releasably store a tool (not shown) therein. In the embodiment shown, a carabiner having a spring loaded clasp is used as the link member 28. It is understood that other link members 28 can be used such as a split ring, a snap swivel, and a spring clip, and others such as those disclosed in U.S. Pat. Nos. 5,224,366; 4,584,858; 4,766,191; 5,031,430; and 5,050,414, for example, each of which is hereby incorporated herein by reference. It is also understood that the link members 28 can be releasably attached to the rack 14 of the main body 12. The link members 28 can be released from the main body 12 by a release button (not shown). Alternatively, the retaining member 18 can be disposed on the link member 28 such as a spring loaded detent, for example.

The tools releasably stored by the link members 28 can be any conventional tool or family of tools used to accomplish a task. For example, in the medical field, the tools can include a knife, clippers, scissors, a thermometer, a hemostat, a flashlight or other lighting device for medical related uses, a calculator, a micrometer, calipers, keys, a reflex hammer, a pen, a marker, and other tools, as desired.

A clip 30 is disposed on a second surface 32 of the main body 12, as clearly shown in FIG. 2. The clip 30 can be any conventional clip or fastener which connects the tool holder 10 to a support structure (not shown) such as a belt, a belt loop, a pocket, a waistband, or other support structure, for example. In the embodiment shown, the clip 30 is a belt clip, although any conventional clip or fastener can be used such as a spring clip, snap swivel, split ring, or carabiner, for example. It is understood that the main body 12 can also be releasably attached to the clip 30.

In use, the tool holder 10 efficiently stores and organizes the tools or family of tools. An exemplary use of the tool holder 10 is use by a health care provider to organize and store medical tools when not in use, while also keeping the tools conveniently available for use. However, the tool holder 10 is not limited to use by a health care provider for storing medical tools. It is understood that the tool holder 10 can be used for a variety of activities such as with various hobbies, fishing, sewing, assisting children with school supplies, and the like, for example.

The clip 30 of the tool holder 10 is typically attached to the belt, the belt loop, the pocket, or the waistband of the clothing of the user, or other support structure. When attached to the clothing of the user, the tool holder 10 and the tools attached thereto are readily available to the user. Typically, a family of tools used to conduct a task or series of tasks are provided.

For the health care provider, the tools can be used for diagnostics, routine care, and other tasks, for example. When it is desired to conduct a specific task, the desired tool necessary for the task is released from the link member 28 of the tool holder 10 for use. When the specific task is completed, the tool is re-attached to the link member 28 of the tool holder 10 for storage until needed again.

An efficiency of the use of the tools by the user is maximized by having all of the tools readily viewable and available for a specific task. Other known storage structures typically store tools in an unorganized manner, often requiring removal of the tools from the storage structure and sorting in order to find the desired tool.

The measuring tape 24 facilitates length measurements by a user as desired, without the requirement of carrying a separate tool or measuring device. Similarly, the clock 20 permits the user to quickly and efficiently view the current time. The clock 20 also facilitates timing of an event such as taking a pulse of a patient or keeping track of the time required to conduct a specific task, for example. This also eliminates the need to carry a separate timer, clock, or watch. In poorly lit areas, the source of light can be caused to illuminate the display area of the clock 20 to facilitate a viewing thereof.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A tool holder comprising:
a main body adapted to be attached to a support structure;
a fastener rack disposed on said main body; and
a plurality of link members depending from said rack, each of said link members adapted to releasably receive a tool therein, wherein the tool can be released from said link member during use.

2. The tool holder according to claim 1, further comprising a measuring tape disposed in said main body.

3. The tool holder according to claim 1, further comprising a clock disposed in said main body.

4. The tool holder according to claim 1, wherein said main body includes a clip disposed thereon adapted to be attached to the support structure.

5. The tool holder according to claim 1, wherein said rack includes a plurality of recesses formed therein, each of said recesses including a retaining member for supporting one of said link members.

6. The tool holder according to claim 1, wherein said link members are carabiners.

7. The tool holder according to claim 1, wherein said link members are adapted to releasably receive at least one of a knife, tweezers, a staple remover, an identification badge, a pair of scissors, a thermometer, a hemostat, a flashlight, a lighting device for medical equipment, a calculator, a micrometer, a caliper, a key, a reflex hammer, a pen, and a marker.

8. A tool holder comprising:
a main body adapted to be attached to a support structure, said main body including a plurality of recesses formed therein;
a link member disposed in each of the recesses of said main body, each said link member adapted to releasably receive a tool therein, wherein the tool can be released from said link member during use; and
at least one retaining member disposed between said main body and said link members to attach said link members to said main body.

9. The tool holder according to claim 8, wherein said retaining member releasably attaches said link member to said main body.

10. The tool holder according to claim 8, wherein said at least one retaining member extends through the recesses of said main body.

11. The tool holder according to claim 8, wherein said main body includes a clip disposed thereon adapted to be attached to the support structure.

12. The tool holder according to claim 8, further comprising a fastener rack disposed on said main body, wherein the recesses are formed in said rack.

13. The tool holder according to claim 8, wherein each said link member is a carabiner.

14. The tool holder according to claim 8, wherein the tool is at least one of a knife, tweezers, a staple remover, an identification badge, a pair of scissors, a thermometer, a hemostat, a flashlight, a lighting device for medical equipment, a calculator, a micrometer, a caliper, a key, a reflex hammer, a pen, and a marker.

15. A tool holder comprising:
a main body adapted to be attached to a support structure;
a fastener rack disposed on said main body including a plurality of recesses formed therein;
at least one retaining member extending through the recesses of said rack; and
a link member disposed in each of the recesses of said rack and depending from said retaining member, each said link member adapted to releasably receive a tool therein, wherein the tool can be released from said link member during use.

16. The tool holder according to claim 15, further comprising a measuring tape disposed in said main body.

17. The tool holder according to claim 15, further comprising a clock disposed in said main body.

18. The tool holder according to claim 15, wherein each said link member is a carabiner.

19. The tool holder according to claim 15, wherein said link members are adapted to releasably receive at least one of a knife, tweezers, a staple remover, an identification badge, a pair of scissors, a thermometer, a hemostat, a flashlight, a lighting device for medical equipment, a calculator, a micrometer, a caliper, a key, a reflex hammer, a pen, and a marker.

20. The tool holder according to claim 15, wherein each said link member is adapted to releasably receive a medical tool.
